(19) United States
(12) Patent Application Publication
(10) Pub. No.: US 2018/0170323 A1
(43) Pub. Date: Jun. 21, 2018

(54) Vehicle self lifting device

(71) Applicants: Samuel Darius, Philadelphia, PA (US); Taciana Darius, Philadelphia, PA (US)

(72) Inventors: Samuel Darius, Philadelphia, PA (US); Taciana Darius, Philadelphia, PA (US)

(21) Appl. No.: 15/530,240

(22) Filed: Dec. 16, 2016

(51) Int. Cl. B60S 9/12

(52) U.S. Cl. CPC B60S 9/12

(57) ABSTRACT

This device is designed for any automobile to have a built in vehicle jack and wheel chuck to safely change a tire or tires without the need to use a manual jack as all car manufactures supply somewhere in there car. This Vehicle Self Lifting Device uses a Hydraulic Air Compressor which is mounted on four locations on the chassis of the vehicle for solid and stable lifting of the vehicle. This device can be used on one or more sides of the vehicle as required by the operator of the device. Once the device is needed the operator will have to place the vehicle in a parked position in order to begin vehicle lifting operation. By pressing switch inside the vehicle the hydraulic air compressor will begin to lift the vehicle on the required side front or back of the vehicle or all four locations. Once the vehicle lifting is desired a lock pin inserted through device for safety. Then a wheel chuck that is housed within the vehicle is pulled down from the chassis to the ground to prevent any additional movement of the vehicle. Once the vehicle task is completed a reverse procedure is required to have the device in unused position.

### BRIEF DESCRIPTION OF THE DRAWINGS

FIG. 1 illustrates a planar side view of a lifting arrangement in operation, in accordance with an embodiment of the present disclosure;

FIG. 2 illustrates a general perspective view of a lifting device, in accordance with an embodiment of the present disclosure;

FIG. 3 illustrates a planar view of the lifting device, in accordance with an embodiment of the present disclosure;

FIG. 4 illustrates an exploded perspective view of the lifting device, in accordance with an embodiment of the present disclosure; and

FIG. 5 illustrates a planar view of a support device in relation to a wheel, in accordance with an embodiment of the present disclosure.

### DETAILED DESCRIPTION

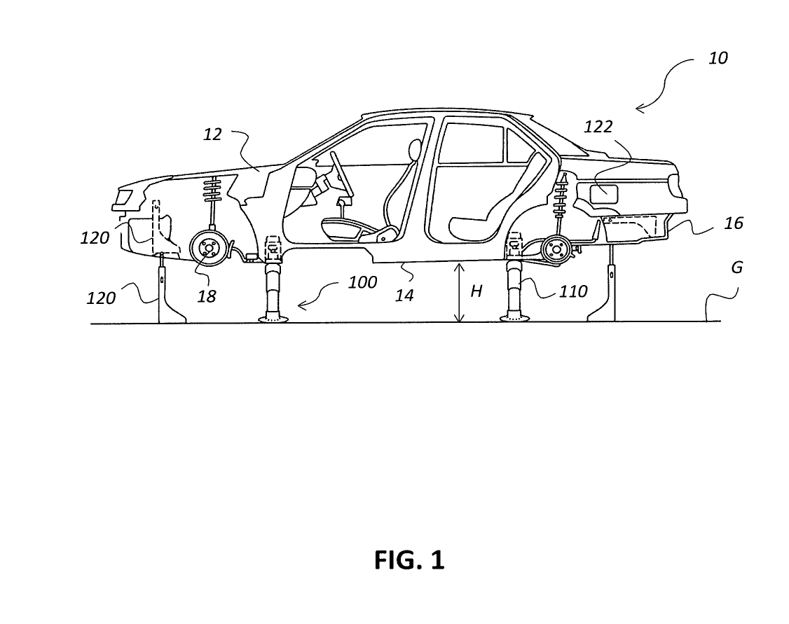

FIG. 1 illustrates a lifting arrangement 100 in accordance with an embodiment of the present disclosure. FIG. 1 provides an exemplary vehicle 10 lifted to a certain height H above the ground G by means of the presently disclosed lifting arrangement 100. In an embodiment, the lifting arrangement 100 may be adapted to be disposed underneath a body 12 of the vehicle 10. In particular, the lifting arrangement 100 and its components may be mounted to a base 16 of the vehicle 10, to a lower side 14 thereof. The lifting arrangement 100 of the present disclosure may be configured to raise the vehicle 10 to the desired height H above the ground G for carrying out necessary repairs operations underneath.

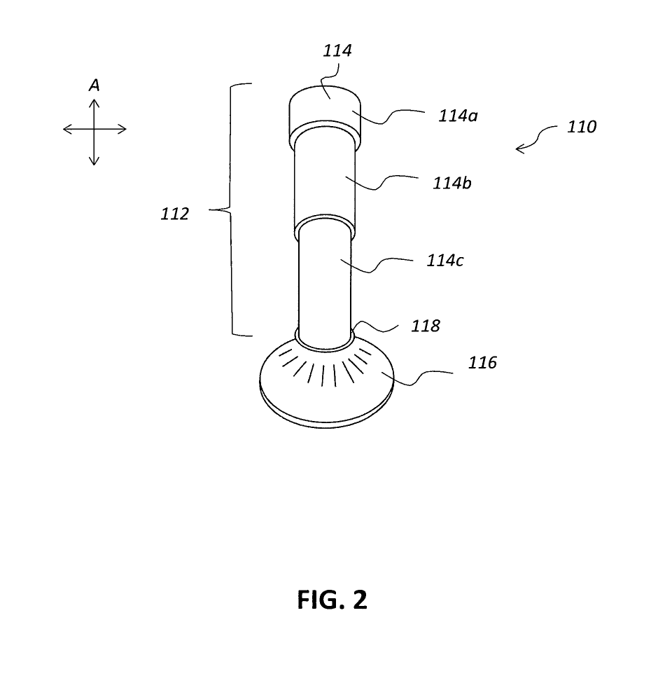

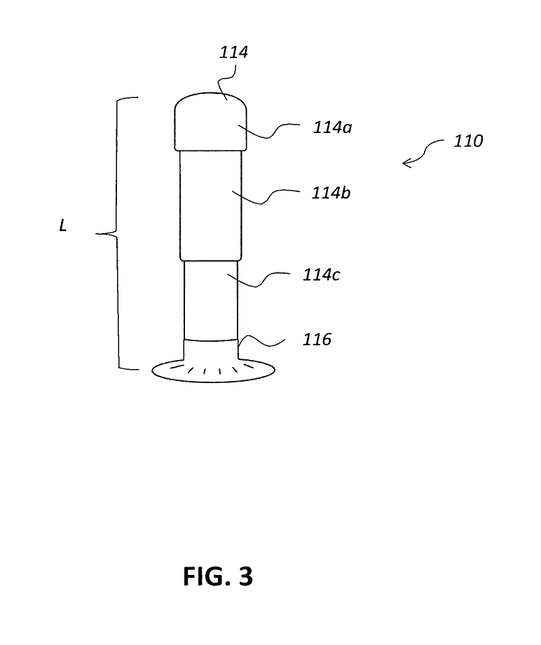

In an embodiment, the lifting arrangement 100 may include a lifting device 110 and a support device 120. FIGS. 2-4 illustrate different views of the lifting device 110 in accordance with an embodiment of the present disclosure. According to an embodiment, the lifting device 110 may be configured to raise and support the vehicle 10 above the ground G. In a preferred embodiment, the lifting arrangement 100 may include four lifting devices 110 mounted below four corner locations on the body 12 of the vehicle 10. It may be contemplated that such four lifting devices 110 would provide balanced and stable lifting of the vehicle 10.

Further the operator can also operate only two lifting device 110 located on either the front or the back to lift the corresponding side of the vehicle 10. In an embodiment, a length L of the lifting device 110 may be varied to control the lift height H above the ground.

In an embodiment, the lifting device 110 may include a rod portion 112. Further in an embodiment, the rod portion 112 may include multiple cylindrical elements 114. In the exemplary embodiments, the rod portion 112 is shown to include three cylindrical elements 114a, 114b, 114c. However it may be understood that any number of cylindrical elements 114 may be provided as per the requirements of the lifting arrangement 100. In an embodiment of the present disclosure, the cylindrical elements 114 may be disposed inside each other defining a telescopic structure for the rod portion 112. This telescopic structure may allow one cylindrical element 114 to slide inside the other cylindrical element(s) and therefore enable to vary the length L of the lifting device 110 along a longitudinal axis A. This in turn controls the lift height H of the vehicle 10 above the ground G in the lifting arrangement 100.

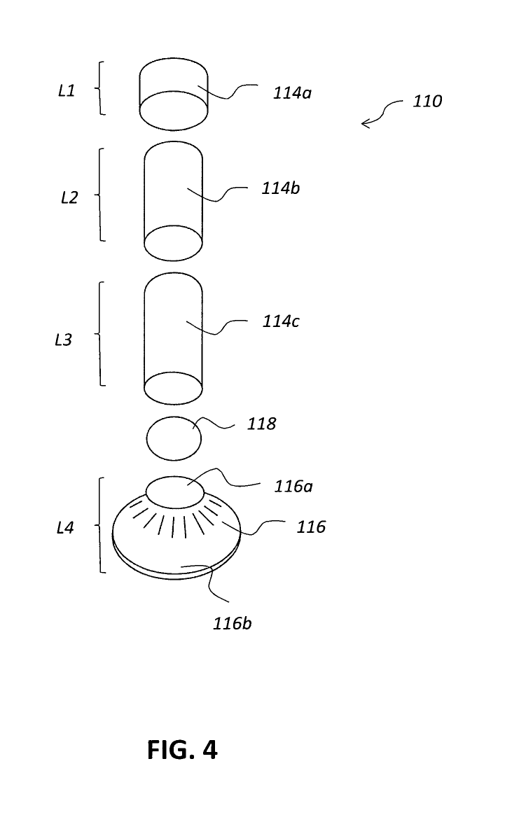

For the purpose of the present disclosure, the cylindrical elements 114 have been labelled as upper cylindrical element 114a, middle cylindrical element 114b and lower cylindrical element 114c. It may be understood that the cylindrical elements 114 may be of equal or different lengths along the longitudinal axis A. Referring to FIG. 4, the upper cylindrical element 114a is shown shorter in length L1 as compared to the length L2 of middle cylindrical element 114b and the length L3 of the lower cylindrical element 114c. Further the middle cylindrical element 114b is shown shorter than the lower cylindrical element 114c. It may be understood that these lengths are exemplary only, and the comparative lengths may be varied based on the application requirements. For example, in some other embodiment, the upper cylindrical element 114a may be longest compared to the middle and lower cylindrical elements 114b, 114c. It may be understood that the total length of the lifting device 110 may determine the maximum lift height H for the vehicle 10.

In an embodiment, each cylindrical element 114 may include a collar (not illustrated) at one or more of its ends. The said collars may be disposed towards the inner sides of the cylindrical elements 114. In an embodiment, the cylindrical element 114 may further include a collar disposed somewhere around a middle of its longitudinal length. It may be contemplated by a person skilled in the art that the collar prevents one cylindrical element 114 to disengage from the other cylindrical element 114 with which it may have a telescopic engagement. The collar may further be adapted to limit the sliding movement, that is, the linear translation of one cylindrical element 114 inside other cylindrical element 114 and thus provide control over the extent of varying the length L of the lifting device 110.

In a further embodiment, the lifting device 110 may include a sliding lock (not illustrated). The sliding lock may include a hole provided in one of the cylindrical elements. Further the sliding lock may include a pin to be engaged in the hole in order to inhibit any relative sliding movement between the cylindrical elements 114, and thus restrains the extent of the length of the lifting device 110. In other embodiment, the sliding lock may include a plurality of such holes disposed along the longitudinal length of the cylindrical elements 114 in order to provide more granular control to vary the length of the lifting device 110. It may be contemplated by a person skilled in the art that the sliding lock arrangement provides safety by preventing unanticipated collapse of the lifting device 110.

As illustrated in the embodiment of FIGS. 2-4, the lifting device 110 may also include a base portion 116. The base portion 116 may be disposed at a bottom end of the rod portion 112. In an embodiment, the base portion 116 may be a rubber cup similar to those generally employed with a sink plunger. It may be understood that the base portion 116 may primarily be in the shape of a hollow rubber ball cut in half. It may be seen that the base portion 116 may have the diameter varying along its longitudinal length L4. The base portion 116 may have an upper section 116a with a diameter and a lower section 116b with a wider diameter as compared to the diameter of the upper section 116a.

The base portion 116 may be fixedly connected to the rod portion 112 at its upper section 116a. In an embodiment, the lifting device 110 may include a rubber seal 118 adapted to be disposed between the rod portion 112 and the base portion 116. The rubber seal 118 may be configured to provide a leak proof joint and better secure the base portion 116 to the rod portion 112. In particular, the upper section 116a of the base portion 116 may engulf the lower cylindrical element 114c at its bottom end. Further the lower section 116b of the base portion 116 may be adapted to be engaged with the ground G, when the lifting arrangement 100 is in operation. The cup shape of the base portion 116 may assist in creating some suction force for proper engagement of the lifting device 112 with the ground G. Further the elastic nature of the base portion 116 may help to reduce sudden shocks during the lifting operation.

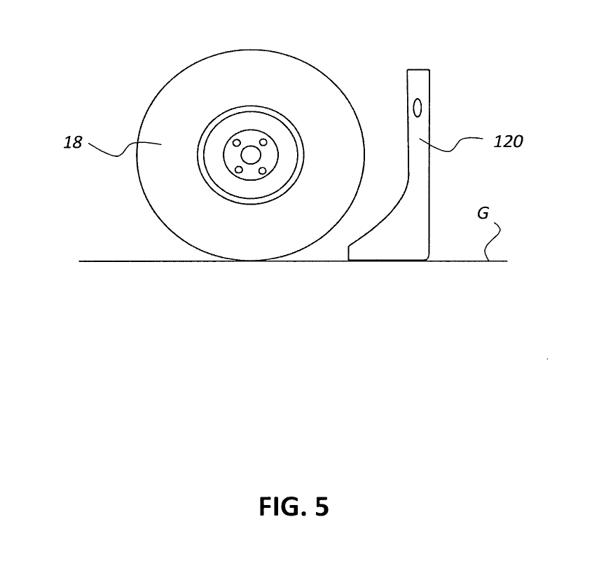

FIG. 5 illustrates the support device 120 in relation to a wheel 18 of the vehicle 10, as per an embodiment of the present disclosure. The support device 120 may be adapted to be mounted to the body 12 of the vehicle 10 in a folded position, as illustrated in FIG. 1. In an embodiment, the lifting arrangement 100 may include two support devices 120 disposed in connection with one of the wheels 10 at the front and the back of the vehicle 10 respectively, again as illustrated in FIG. 1. In other embodiment, the lifting arrangement 100 may include four support devices 120 disposed in connection with all the four wheels 18 of the vehicle 10. The support devices 120 may be configured to inhibit the movement of the vehicle 10 in either direction. The support device 120 may be in the form of a vertical extending bar with a bottom portion having a wedge shape. The said bottom portion may be adapted to be engaged with a lower segment of the wheel 18 to limit the rolling movement thereof. It may be understood that the support device 120 may be configured to engage with the wheels 18 to hold the vehicle 10 in position, while the lifting operation is being carried out.

Referring back to FIG. 1, the lifting arrangement 100 may further include a lifting source 122. In an embodiment, the lifting source 122 may be a pneumatic or a hydraulic pressure source. It may be contemplated that the lifting source 122 may be an air compressor or the like. In a preferred embodiment, the lifting source 122 may be a hydraulic air compressor. The said compressor may be of rotary type or reciprocating type, or any other type suitable for the operation of the present disclosure. In an embodiment, the lifting source 122 may be fluidly connected to the lifting device 110. It may be contemplated that the lifting source 122, in particular, provides the hydraulic pressure (power) to the lifting device 110. This provided pressure initiates the sliding movement of the cylindrical elements 114 therein, extending the length L of the lifting device 110.

In an embodiment, the lifting source 122 may be positioned inside the body 12 of the vehicle 10, for example the boot space of the vehicle 10. In an alternative embodiment, the lifting source 122 may be mounted on the lower side 14 of the base 16 in the vehicle 10. In an embodiment, the lifting source 122 may include a single compressor for the entire lifting arrangement 100. In an alternative embodiment, the lifting source 122 may include multiple independent compressors for each of the lifting device 110. Further in an embodiment, the power to run the lifting source 122 may be withdrawn from the engine in the vehicle 10. Alternatively, the lifting source 122 may be powered by a separate power source like a battery provided in the vehicle 10.

### INDUSTRIAL APPLICABILITY

It is required that the vehicle is raised to a certain height above the ground for changing a punctured tire. Generally the desired height may be a height in which the wheel that is needed to be changed has disengaged from the ground underneath. In other cases, the height may be slightly higher in case the operator may need to slide underneath the vehicle for making any repairs or the like. The conventional method requires a manual jack whenever the vehicle is needed to be raised above the ground, which is required to be always carried around in the vehicle. The manual lifting operation is usually time demanding and generally involves lot of hassles. Also such lifting operation is usually very tiresome for the operator. So there is a need of an automatic lifting arrangement for a vehicle which mitigates the problems of the conventional manual jack.

The lifting arrangement 100 of the present disclosure has been termed as “AVAC—Auto, Vehicle, Air Jack, Compressor”. The present lifting arrangement 100 is designed to be installed in any automobile or vehicle. The lifting arrangement 100 is configured to lift and raise the vehicle 10 to a desired height H above the ground G, as desired by the operator. The present lifting arrangement 100 is automatic, that is, the operator may be required to only press a button (not illustrated) or the like to start the lifting operation. The operator would put the vehicle 10 in a parked state and engage the lifting arrangement 100 by pressing the button. In some case before the lifting operation is started, the operator may engage the support device 120 to inhibit the movement of the vehicle 10 and prevent any possible accidents. The operator may again press the button or the like to stop the lifting operation when the vehicle 10 may have reached the desired height H above the ground G. The button may be usually located inside the vehicle 10 such that the button is in reach to be pressed from the outside of the vehicle 10 as well.

It may be understood that pressing the button specifically powers on the lifting source 122 which starts supplying the pressurized fluid to the lifting device 110. The supplied pressurized fluid extends the length L of the lifting device 110 which engages with the ground G at base portion 116. It may be contemplated by a person skilled in the art that the total length L of the lifting device 110 would be approximately equal to the sum of the lengths L1, L2, L3, L4 of its components. The reactive forces generated by pushing against the ground G would provide the necessary lifting force to raise the vehicle 10 above the ground G. Once the vehicle 10 is raised to the desired height H, the operator may engage the sliding lock for the safety purpose. The sliding lock may stop collapse of the lifting device 110, and thus prevent possible fall of the vehicle 10 and any accidents associated with it. The operator may further engage the support device 120 afterwards to inhibit the movement of the wheels 18 and thereby prevent any possible accidents due to the travel of the vehicle 10. With the lifting arrangement 100 of the present disclosure, the operator can easily lift the vehicle 10 above the ground G and make necessary repair operations.

While certain exemplary embodiments have been described and shown in the accompanying drawings, it is to be understood that such embodiments are merely illustrative of and not restrictive on the broad present disclosure, and that this present disclosure is not limited to the specific constructions and arrangements shown and described, since various other modifications and/or adaptations may occur to those of ordinary skill in the art. It is to be understood that individual features shown or described for one embodiment may be combined with individual features shown or described for another embodiment.

What is claimed:

1. I claim a built in vehicle jack system housed in the frame or uni-body of a vehicles. By pressing switch inside the vehicle the hydraulic air compressor will begin to lift the vehicle on the required side front or back of the vehicle or all four locations of the vehicle.

2. I claim a built in vehicle wheel chuck in the frame or uni-body of a vehicle. The operator may further engage the support device afterwards to inhibit the movement of the wheels and thereby prevent any possible accidents due to the travel of the vehicle.
